(19) United States
(12) Patent Application Publication
(10) Pub. No.: US 2025/0369730 A1
(43) Pub. Date: Dec. 4, 2025

(54) CAMOUFLAGE MATERIAL FOR AVOIDING DETECTION FROM THERMAL IMAGING

(71) Applicant: Bulldog Equipment, LLC, Stuart, FL (US)

(72) Inventor: Jason SIMIONE, Stuart, FL (US)

(21) Appl. No.: 19/223,374

(22) Filed: May 30, 2025

Related U.S. Application Data
(60) Provisional application No. 63/654,537, filed on May 31, 2024.

(51) Int. Cl. F41H 3/02; B32B 3/26; B32B 27/06; B32B 27/12; B32B 27/16; B32B 27/36; B32B 33/00; B32B 38/00

(52) U.S. Cl. CPC F41H 3/02; B32B 3/266; B32B 27/065; B32B 27/12; B32B 27/16; B32B 27/36; B32B 33/00; B32B 2038/008; B32B 2250/05; B32B 2250/40; B32B 2255/02; B32B 2255/205; B32B 2307/56; B32B 2311/24; B32B 2437/00

(57) ABSTRACT

The IR cloaking material comprises five bonded layers: a first fabric layer with outer and inner surfaces, a metalized film, a plastic film with air bubbles, a second metalized film, and a second fabric layer. It includes multiple vents formed as continuous openings extending through all layers. The outer surface of the first fabric layer may feature a camouflage pattern, a grid of cords, or both; the fifth layer may display a different camouflage. The metalized films may include materials such as gold, silver, nickel, aluminum, copper, mylar, graphene, or combinations thereof. The material can be shaped into a cape with a hood to mask heat signatures and enhance concealment.

### CROSS-REFERENCE TO RELATED APPLICATIONS

This application claims priority from and is related to U.S. Provisional Application No. 63/654,537, entitled “Camouflage Material For Avoiding Detection From Thermal Imaging” with attorney docket number 9005-V0008, filed May 31, 2024 are commonly assigned herewith to Bulldog Equipment, LLC, and hereby incorporated into the present application by reference in its entirety.

### FIELD OF THE INVENTION

The present invention generally relates to the field of material used for apparel and coverings and, more particularly, relates to a material to avoid detection from thermal imaging.

### BACKGROUND OF THE INVENTION

Over the last decade, there has been a dramatic increase in the use of thermal imaging for military operations. Cameras on drones, vehicles, helicopters, aircraft, and satellites detecting heat signatures have become a challenge. This challenge to avoid detection by thermal imaging has spurred more research for camouflage technology to avoid detection by thermal imaging. Many novel camouflage concepts are being developed, including BAE Systems' adaptive vehicle cloaking technology, Hyperstealth Biotechnology's light-bending Quantum Stealth material technology, and the Japanese invisibility cloak created by Dr. Susumu Tachi, which uses nanoantennae technology to redirect light waves around objects.

### SUMMARY OF THE INVENTION

The infrared (IR) cloaking material described comprises multiple embodiments designed to reduce IR signature while maintaining camouflage. In one embodiment, the material includes a layer of metalized film bonded between two fabric layers, each having an inner and outer surface. This composite structure features a plurality of vents that form continuous openings through all three layers. Additionally, the outer surface of the first fabric layer may include a camouflage pattern, a grid pattern of cord, or both. A variation includes a second camouflage pattern on the outer surface of the second fabric layer that differs from the first. The metalized film may be made from materials such as gold, silver, nickel, aluminum, copper, mylar, graphene, or combinations thereof.

Another embodiment incorporates five bonded layers: a first fabric layer, a metalized film layer, a plastic film with embedded air bubbles, a second metalized film layer, and a second fabric layer. Like the first embodiment, it includes continuous vents through all five layers. The outer surface of the first fabric layer may similarly feature a camouflage pattern, grid pattern of cord, or both. A second camouflage pattern may also be applied to the second fabric layer. The metalized films in this embodiment can also be formed from a variety of metals and composites. This layered material can be formed into a wearable item, such as a cape with a hood.

A third embodiment describes a cape formed from a single fabric that has a metallic coating applied to its inside surface, a camouflage pattern on the outside surface, and zig-zag stitching sewn between the two surfaces. This cape includes arm portions and may also incorporate a grid pattern of cord on the outer surface. A hood made from the same coated fabric can be releasably fastened to the cape. Both the cape and hood can utilize metallic coatings such as gold, silver, nickel, aluminum, copper, mylar, graphene, carbon, or combinations thereof. Additionally, spacers such as foam blocks, wire-stiffened arches, or plastic shapes may be placed between the inside surface of the cape and the user to enhance insulation and maintain air gaps for IR signature reduction.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1A is an IR image of two soldiers in a wooded field in a color contrast, according to the prior art;

FIG. 1B is an IR image of two soldiers in a wooded field of FIG. 1A in a color contrast, but the solder on the right is wearing the hooded cape or ghillie suit of IR cloaking material for avoiding detection, according to one embodiment of the present invention, turns with his back towards the camera, according to one aspect of the present invention;

FIG. 1C is an IR image of two soldiers in a wooded field of FIG. 1A in black and white contrast, according to the prior art;

FIG. 1D is an IR image of two soldiers in a wooded field of FIG. 1D in black and white contrast, according to one aspect of the present invention;

FIG. 2 is an interior view of the hooded cape with IR cloaking material, according to one aspect of the present invention;

FIG. 3 is an enlarged interior view of the hooded cape of FIG. 2, with the hood removed, according to one aspect of the present invention;

FIG. 4 is an enlarged interior view of the arm and hood region of the hooded cape of FIG. 2, according to one aspect of the present invention;

FIG. 5 is an enlarged exterior view of the arm region of the hooded cape, according to one aspect of the present invention;

FIG. 6 is a zig-zag pattern sewn into the material of the hooded cape of FIG. 2 to provide customized temperature regulation according to one aspect of the present invention;

FIG. 7 is a nanoparticle tube with various geometric shapes, according to one aspect of the present invention;

FIG. 8 is a first example of a side view illustrating the layers of the IR cloaking material, according to one aspect of the present invention; and

FIG. 9 is a second example of a side view illustrating the layers of the IR cloaking material, according to one aspect of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure and function. Further, the terms and phrases used herein are not intended to be limiting but rather to provide an understandable description of the invention.

### Non-Limiting Definitions

The terms “a,” “an,” and “the” are intended to include the plural forms as well unless the context clearly indicates otherwise.

The term “adapted to” describes the hardware, software, or a combination of hardware and software that is capable of, able to accommodate, to make, or that is suitable to carry out a given function.

The term “another”, as used herein, is defined as at least a second or more. The terms including and/or having, as used herein, are defined as comprising (i.e., open language).

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The terms “comprises” and/or “comprising”, when used in this specification, specify the presence of stated features, steps, operations, elements, and/or components but do not preclude the presence or addition of one or more other features, integers, steps, operations, elements, components, and/or groups thereof.

The term “configured to” describes the hardware, software, or a combination of hardware and software that is adapted to, set up, arranged, built, composed, constructed, designed, or that has any combination of these characteristics to carry out a given function.

The term “coupled”, as used herein, is defined as “connected,” although not necessarily directly and not necessarily mechanically.

The terms “including” and “having,” as used herein, are defined as comprising (i.e., open language).

The term “thermal imaging” is a process in which infrared (IR) energy is converted into a visible thermal image, commonly performed by thermal imaging cameras and other sensors. One example is “thermal radar” in which software provides a stitched, panoramic, 360° view of the detection area using individual frames of thermal images.

### Overview

The presently claimed invention adopts a core principle of thermal dilution and thermal distribution to avoid thermal image detection. This core principle is applied to clothing, covers, and the mitigation of heat transfer to the materials.

### First Example of IR Cloaking Material

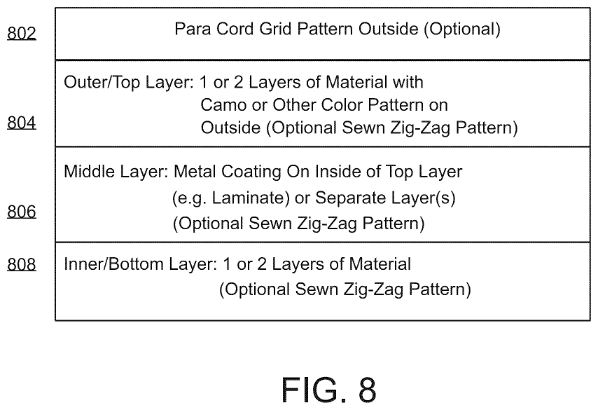

FIG. 8 is a side view illustrating the layers of the IR cloaking material to cover personnel and items that are above ambient temperature. There are multiple layers of material. Starting from the outside, an optional para cord is sewn in a grid pattern 802, as further described below.

Next is the outer/top layer 804, which comprises one or more layers of materials with a camo pattern or other color pattern on the outside surface. This layer may include an optional sewn zig-zag pattern, as further described below.

Next, a middle layer 806 with metal coating on the inside of top layer 804, such as a laminate coating, or in the alternative, a separate layer. This middle layer 808 may also include an optional sewn zig-zag pattern, as further described below.

An inner/bottom layer 808 of one or more layers of material. Also, this inner/bottom layer 808 may include an optional sewn zig-zag pattern, as further described below.

Design and construction of IR cloaking material to provide the ability to reduce or eliminate thermal signature can be made of various types of metals/and metallic coatings ranging from gold, silver, nickel, aluminum, copper, mylar, graphene, and other similar materials or combinations thereof. This is applied in manners and thickness so as to disrupt the ability of the IR cameras to penetrate the material substrate to which they are bonded.

### IR Coatings

Coatings of the materials described above may also be applied to allow waterproofing. In addition, nano particulates: custom-constructed nanoparticles may be applied and embedded into the construction/weaving phase of the material. This technique allows for saturation of the base material with certain particles, preventing the thermal sensors from penetrating the material and detecting the thermal signature created by the user. These nanoparticles can be constructed from gold, silver, nickel, aluminum, copper, mylar, and graphene. Nanoparticles can be added to paint to disperse heat throughout the entire coated surface. The coatings can be applied in such a way as to create a modifiable thermal digital pattern that can be modified with frequency and electrical stimulation.

### IR Chameleon Effect

Graphene Particles may be disposed in a graphene tube. The shapes below are various tetrahedron shapes, diamond shapes, and other geometric shapes. The Diamond can be rotated on demand as the surroundings change.

For example, similar to the Japanese invisibility cloak developed by Dr. Susumu Tachi, cameras can feed video from the front of the vehicle to change the color of the rear of the vehicle. Inversely rear facing cameras can control the modifying of the colors in the front of the vehicle, providing truly active camouflage, allowing the vehicle or uniform to change seamlessly with the environment.

Technical Data of a middle layer 806 with metal coating:
Surface resistance: below 0.05 ohm
Material: copper-polyester-nickel-carbon/Silver metallic laminate.
Shielding: Radio Frequency (RF) & Low Frequency (LF) electromagnetic fields
Frequency range: 30 MHz to 30 GHz
Damping (dB): 95-65 dB

### IR Cloaking Material Applied to A Hooded Cape, Umbrella or Poncho

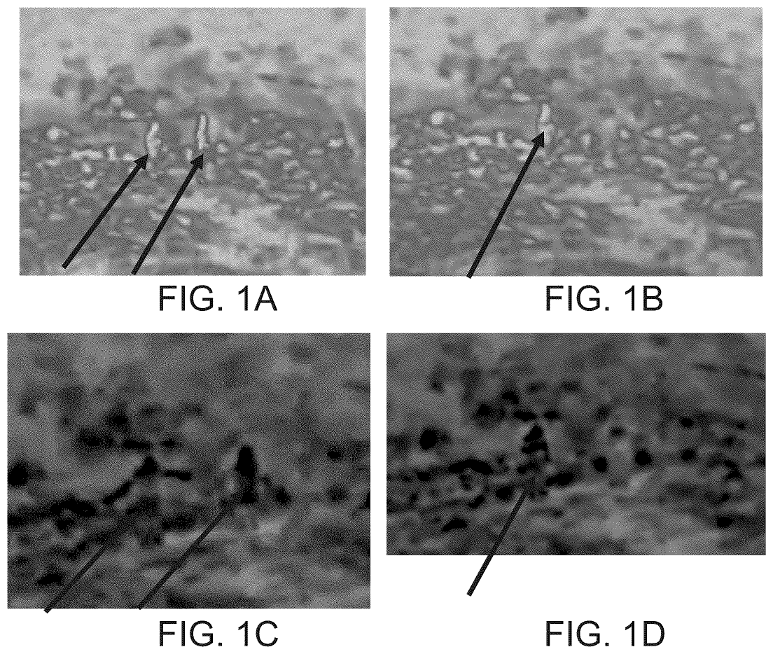

Turning now to FIG. 1A is an IR image of a soldier in a wooded field, according to the prior art. FIG. 1B is an IR image of a soldier in a wooded field of FIG. 1B with black and white colors inverted, according to the prior art. Under thermal imaging and thermal radar, a region of an image whose temperature is greater than the ambient temperature is a white-hot area. Ambient temperature is typically displayed as black. It is unnatural to have an image that is one hundred percent white or black. Typically, heat breakup and distribution are present in these thermal images and thermal radars. For example, rocks hold more heat than trees or soil. The same can be applied to urban areas when concrete, brick, wood, buildings, roof materials, tiles, asphalts, roads, and shrubs dissipate heat at different rates and exhibit different heat capacities. Naturally, there is a random breakup of backgrounds, therefore allowing heat to be released from the IR material covering certain areas and intervals. This allows the covered item to blend in with the surroundings.

A hooded cape is now described using the fabric described above to help prevent personnel from being detected by IR cameras and sensors. The hooded cape may be used for a sniper or other highly trained military or police personnel who specialize in shooting a gun very accurately from far away. The hooded cape can cover users from their heads 204, arms 206, 208, shoulders, and back to their ankles. The hooded cape is also designed in varying widths to cover and conceal any specialty equipment they may be wearing well past their sides, concealing the outline of their body.

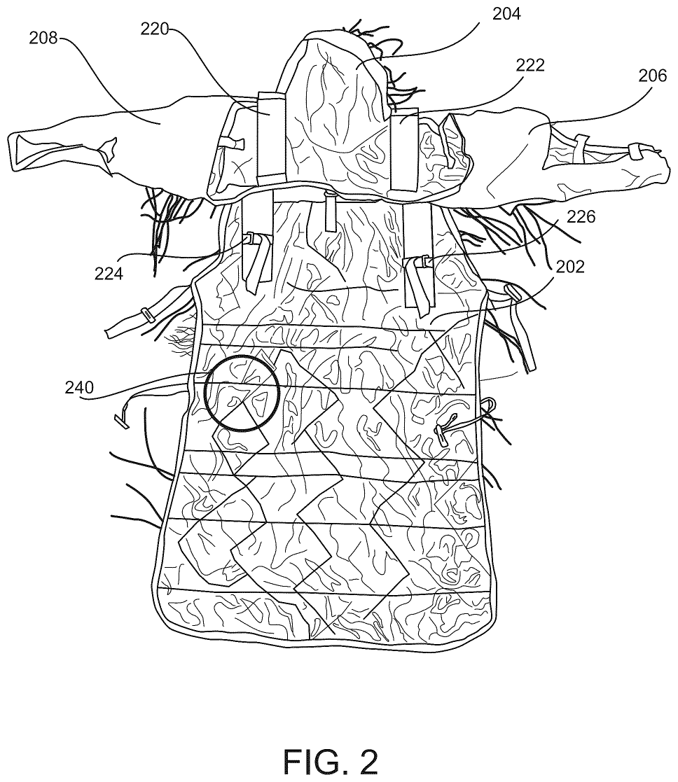

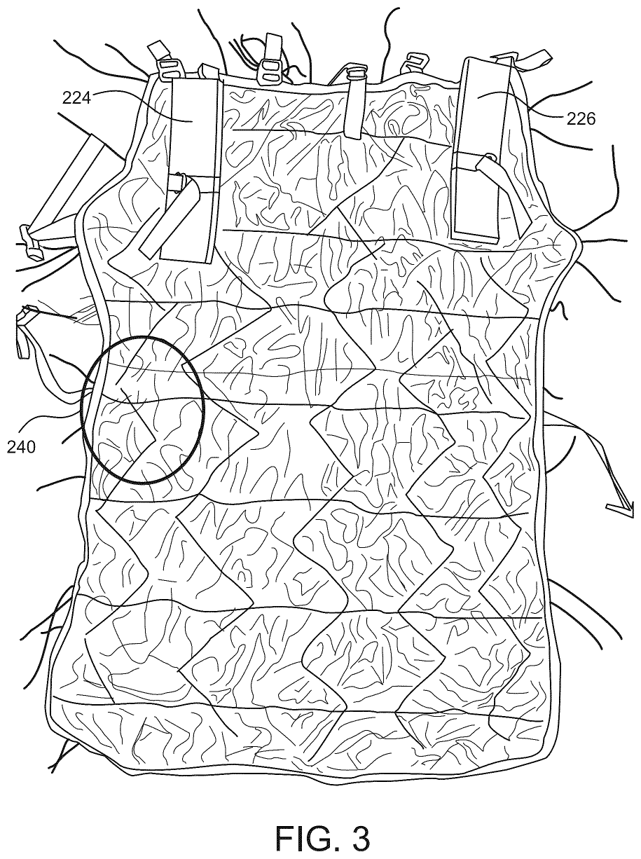

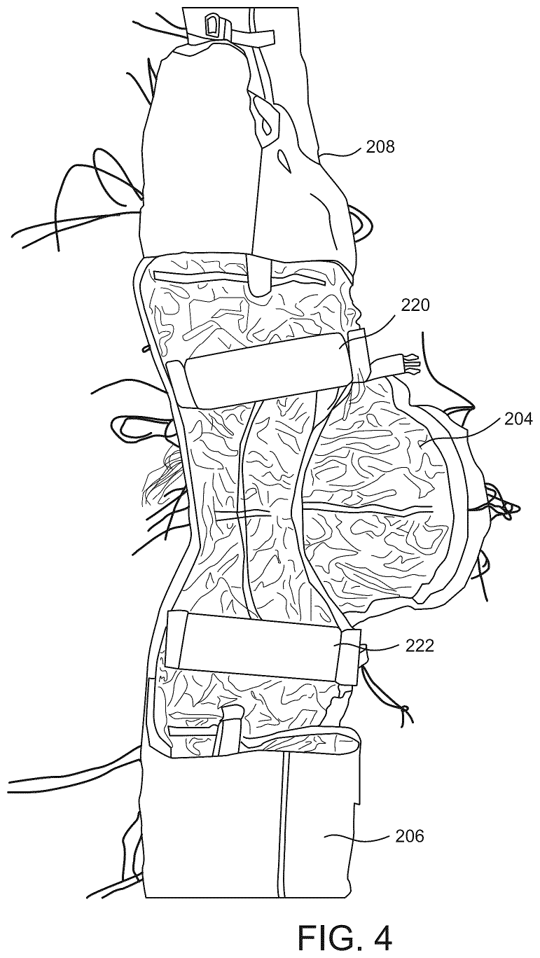

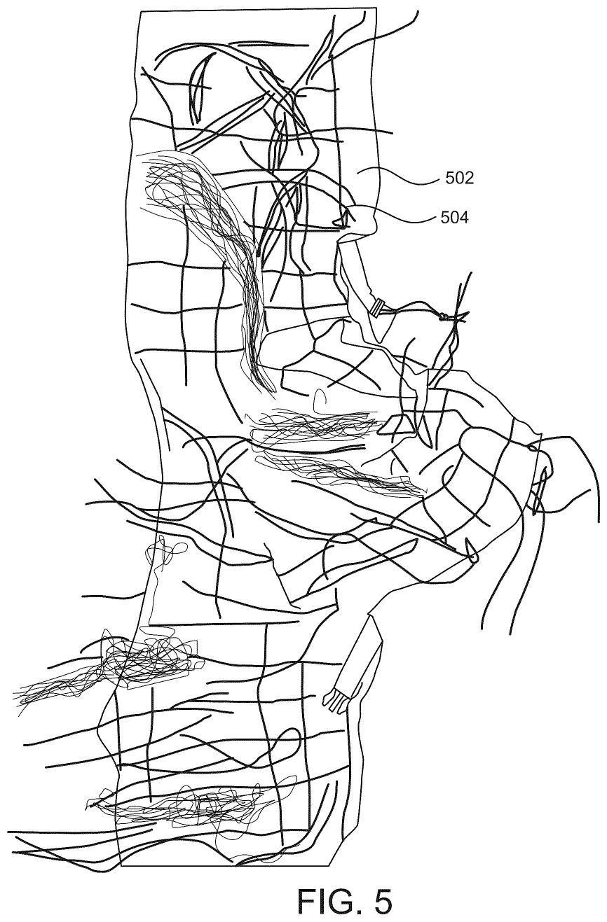

FIG. 2 shows an inside surface of the hooded cape with IR cloaking material, according to one aspect of the present invention. FIG. 3 is an enlarged interior view of the hooded cape of FIG. 2, with the hood removed. FIG. 4 is an enlarged interior view of the arm region of the hooded cape of FIG. 2. FIG. 5 is an enlarged outside surface view of the arm region of the hooded cape.

The hooded cape has several features in multiple layers. Starting from the features and layers closest to the user is a feature to provide heat transfer by using temperature control. The inventor discovered that allowing airflow to pass between the user, vehicle, or any item that requires concealment accentuates the cooling results. This occurs by using multiple types of methodologies.

One methodology for providing heat transfer is to form a space or air gap between the user, vehicle, or item being protected and the IR materials. Ambient airflow allows for the cooling of the covered item.

Create user-definable airflow release points that allow for the removal of heated air at predefined, specific locations, which would enable the covered object to blend into the natural environment.

Over the IR cloaking material is camouflage. One example is a ghillie suit. This camouflage clothing is designed to resemble the background environment, such as foliage, snow, or sand. Typically, it is a net or cloth garment covered in loose strips of burlap (hessian), cloth, or twine, sometimes made to look like leaves and twigs and optionally augmented with scraps of foliage from the area.

In one example, the ghillie is created using fabrics that allow for the camouflage of the user or sniper. The camouflage pattern may vary from a digital camo, such as a Mirage camo, to a US Army scorpion camo, or any colors that disrupt their visual signature to solid colors, such as coyote tan or ranger green.

In one embodiment, at least a portion of the material 502 has a pattern applied to it. One example of a pattern that is used advantageously with the present invention is described in the patent application entitled “Camouflage Pattern Applied to A Surface” with inventors Jason Simione and John Simione, U.S. Patent Application Number US20100088797, and assigned herewith to Bulldog Equipment, LLC of Hollywood Florida which is hereby incorporated by reference in its entirety. A variation of this pattern is shown in the design application entitled “Substrate with Camouflage Pattern”, with inventors Jason Simione and John Simione, U.S. patent application Ser. No. 29/303,336, now USD602258, and assigned herewith to Bulldog Equipment, LLC of Hollywood, Florida, which is hereby incorporated by reference in its entirety.

Adding to this is the ability to add surrounding foliage, grass, or small tree branches to the uniform by attaching them with rubber bands, zip ties, or entangling them into 550 cords, which is added to the exterior fabric in a grid pattern. In one example, a 2″×2″ grid pattern sewn with 550 cord 504 enables attachment of foliage or Jute.

To aid in heat dissipation in one or more layers of IR cloaking material must allow for the removal of trapped air. Otherwise, the air trapped between the ghillie and the soldier heats to the point where concealment is unattainable. This has been controlled by creating a zig-zag pattern or holes 240 sewn into the layers of the materials. The user cuts along the zig-zap pattern between the stitches, allowing for customizable ventilation. This customization allows them to more closely match their thermal surroundings.

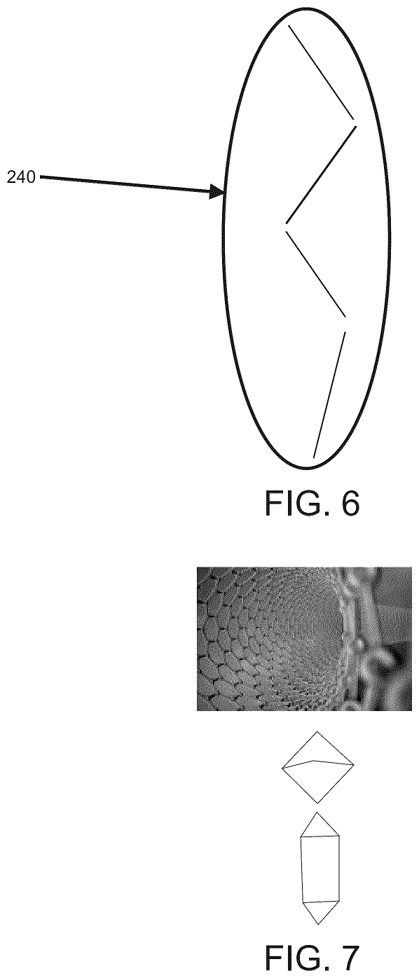

FIG. 6 is a zig-zag pattern 240 sewn into the material of the hooded cape of FIG. 2 to provide customized temperature regulation.

Another important feature for thermal regulation is keeping the hooded cape from coming into direct contact with the user because the user's body heat will eventually saturate the fabric. This has been mitigated by placing arches 220, 222, 224, 226 between the user with foam blocks, which allow for airflow via passive or active ventilation. Spacing of the fabric from the user and a 3D visual effect aids in the visual disruption, creating a natural-looking shape with unrecognizable features.

Items other than foam can be used, such as wire-stiffened arches or plastic arches, rectangular shapes, or shapes made from various items ranging from natural foliage to balled-up articles of debris such as trash, tarps, plastic bags, and bottles found at the final location can be used to supplement the hooded cape.

There are areas for placement of materials between the user and the IR cloaking material or thermal signature-reducing material. A zig-zag pattern is sewn 240 into the materials, allowing the user to create slits between the stitches allowing for custom ventilation and cooling, which mitigates heat buildup, providing a natural look when viewed with thermal cameras and various thermal sensors. On the exterior is sewn 2″×2″, 550 cord 504 for the application of Jute or other materials used to provide concealment, branches, grass, vegetation, etc. 3-dimensional leaf-shaped material can be applied to the exterior of the hooded cape, adding additional capabilities that will mask linear fabric lines that allow others to make out the shape of the sniper.

The cape is attached just below the neck with custom hardware that is designed for rapid donning and doffing while remaining adjustable and virtually indestructible. The component hardware is made of aluminum and hooks into webbing loops.

There are areas for placement of materials between the user and the IR cloaking material. The zig-zag pattern 504 is sewn into the materials, allowing the user to create slits between the stitches allowing for custom ventilation and cooling, which mitigates heat buildup, providing a natural look when viewed with thermal cameras and various thermal sensors. On the exterior is a sewn 2″×2″ Grid Pattern of 550 cord for the application of Jute (Materials used to provide concealment), Branches, Grass, Vegetation, etc. 3-Dimensional leaf-shaped material can be applied to the exterior of the Ghillie Suit, adding additional capabilities that will mask Linear Fabric Lines that allow others to make out the shape of the Sniper.

Zig Zag Ventilation Pattern: Two of these lines are sewn vertically over the entire uniform with an approximate ⅛ to ¼ spacing allowing the soldiers to cut ventilation slits into the ghillie suit. These are spaced every 3-4 inches apart; these can run in any direction throughout the uniform, allowing for customization of the thermal signature.

Although a hooded cape is described above, the IR cloaking material can be applied to an umbrella or poncho or other types of uses.

### Thermal Disruption or IR Cloaking of Vehicles

Creating a solution that will prevent the thermal signatures of vehicles is very similar to the hooded cape or ghillie suit described above. All the above principles and materials apply to both capabilities.

Modifications are necessary for the mounting of the IR cloaking material or thermal materials to the vehicles, depending on the application desire based upon the military commander's decision on what is preferred, depending upon the ability and location of the enemy.

Military leaders and commanders want the ability to have multiple options:

The stand-alone structure that the vehicle can park under is similar to a portable carport. Essentially, there are four posts with thermal covering for a roof that covers the sides to the ground.

Tent pole structures that support current 3D Cammo Netting are staked around the vehicle and upon the vehicle, preventing a shape from being easily distinguished. This is similar to a tent attached to the apparatus. The goals are to break up the linear shapes of current aircraft, helicopters, and 4-wheel quads such as razors, trucks, tanks, fuel trucks, etc.

Hard Point Attachments: These are mounted to the vehicle that may remain while the vehicle is underway. they may be attached to existing hardware or panels attached with hook and loop fasteners such as Velcro® fasteners, magnets, nuts and bolts, screws, zip ties, buckles, snap-hooks, adjuster bars/triglides and webbing, slides, cord locks, zipper pulls, and modular buckles having alternative components adaptable to different sizes and configurations, draw-strings, hook and loop fasteners, buttons, and magnets or a combination of all that can be used to attach either in a semi-permanent or permanent manner that covers the entire vehicle from the very top to the bottom of the wheels.

Thermal Cooling: As with the hooded cape or ghillie suit, there needs to be a gap and or insulation preventing the increased temperatures from the engine, exhaust, brakes, and bearings. A gap and or insulation is needed in the positioning of the external fabrics and netting, allowing natural ventilation to passively cool the air between the vehicle and the materials.

Insulated Materials: Insulated thermal barrier-coated materials allow the slowing of heat transfer, thus providing the ability to maintain the desired temperature, which provides a longer period of time from the heat of the item to affecting the external temperature of the camouflage.

Insulation Materials include: foam, graphene, ceramic, hardy board, membrane infused concrete sheets, aluminum panels with a honeycomb interior layer, aluminum honeycomb flex-core.

Active cooling: active cooling of the bearings, brakes, brake pads, drums, exhaust system, and engine compartment, as well as the generator, may be necessary if the fabrics being used can't conceal the extreme heat signature. This will be done with water combined with antifreeze. There would be a tank with a nonflammable substance spraying coolant onto the components that are extremely hot. Spraying a water-based substance with a form of anti-freeze via piping from the vehicle by way of the air compressor that is already installed and used to inflate air bags and tires via piping to the high-temperature area. This can be done automatically or manually, for short periods of time to rapidly cool. For example, the brakes and rotors are used once the vehicle is preparing the thermal cover, preventing the heated area from affecting the concealment capability. A compressed water-based high-powered mist will rapidly cool any areas deemed too hot.

Active Cooling of Tents and Covers: Air flow can be blown via compressor through tubes with nozzles to transfer hot air from under the cover or tent into areas with suppressed ventilation, allowing a controlled release dependent upon the external temperature and the internal temperature of the cover. This can be done in zones by creating a digitized off-gassing of heated air and a digital thermal background in line with the surrounding area. Once again, use the equipment already installed on the vehicles, and if necessary, supplemental fans can easily be added to this procedure.

Passive Cooling: This can be designed by mounting the thermal blocking fabric on Panels mounted to the vehicle on ½″ Channels secured to the vehicle. This separation between the vehicle and the thermal panel will allow for airflow between the thermal materials and the vehicle, facilitating cooling regardless of movement. Also, the replacement of panels will be quick and easy, as well as secure while underway. We can use C channels or hexagonal channels depending on the user's design requirements.

Whips: Whips made of fiberglass or carbon fiber can be mounted to the vehicle, similar to radio antennas, except instead of pointing up, they can be laid to the side of the vehicle, allowing the thermal fabric to remain off of the vehicle and easily secured to the ground, like the arch of tent poles. This will create rapid deployment and visual obstruction of the vehicle shape.

Roll a Tube Tent Poles: These are flat and rolled up in a ball. Once deployed, they snap into a round tube. This allows for rapid deployment and minimal size for ease of storage.

### Example of IR Cloaking Material With A Bubble Layer

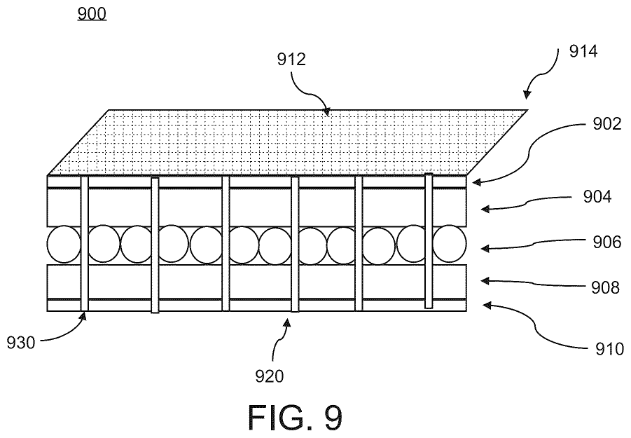

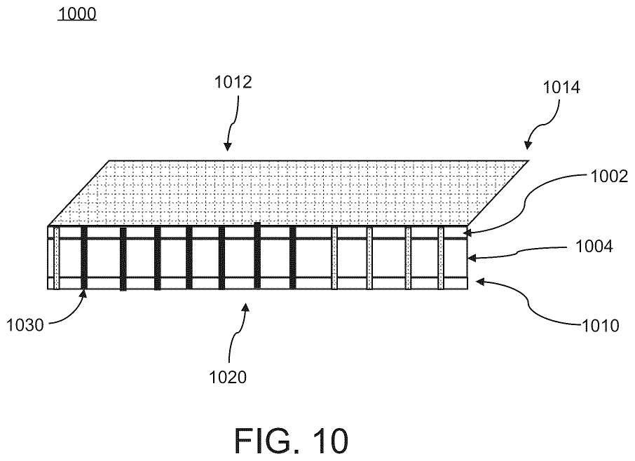

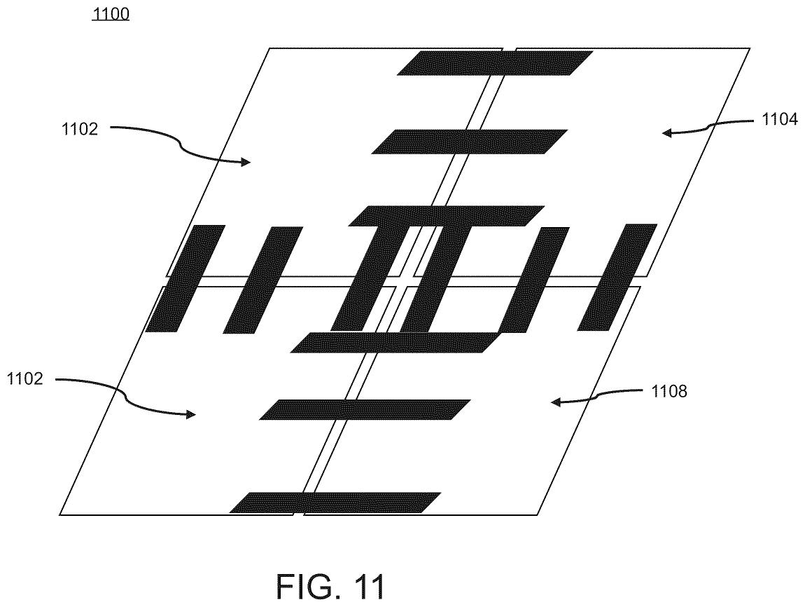

FIG. 9 is a second example of a side view 900 illustrating the layers of the IR cloaking material to cover personnel and items that are above ambient temperature. There are multiple layers of material. Layer 902 is a synthetic fabric, such as nylon or polyester. Examples of synthetic fabric include but are not limited to Cordura® fabric, Sunbrella® fabric, and Weblon® fabric. An optional first camouflage pattern 912 is printed on the outside of the synthetic fabric 902. Next is a metalized film layer 904 of highly reflective metalized film, such as aluminum polyester film. Next, a layer of bubbles, typically air bubbles, formed in a plastic sheet, such as polyethylene, layer 906. This may be a single layer of bubbles or multiple layers of bubbles. The air bubbles are bonded between the two metalized film layers 904 and 908. These metalized film layers 904 and 908 are highly reflective metalized films, such as aluminum polyester film. The design and construction of the metalized file provide the ability to reduce or eliminate the thermal signature. The metalized film can be made of various types of metals/and metallic coatings, ranging from gold, silver, nickel, aluminum, copper, mylar, graphene, and other similar materials or combinations thereof. This is applied in manners and thickness so as to disrupt the ability of the IR cameras to penetrate the material substrate to which they are bonded. The two layers 904 and 908, and the layer of bubbles 906, form an industrialized strength, lightweight yet durable insulation, and are a fire-rated radiant barrier. An example of such material is available from US Energy Products, located in Miami, Florida.

Layer 910 is a synthetic fabric, such as nylon or polyester, as described for the first layer 902. An optional second camouflage pattern 920 is printed on the outside of the synthetic fabric 910. The first camouflage pattern and the second camouflage pattern may be the same pattern. However, to increase versatility, the first camouflage pattern may be different than the second camouflage pattern. For example, the first camouflage pattern may be a desert camouflage pattern, and the second camouflage pattern is a forest or winter snow pattern. “Camouflage Pattern Applied to A Surface” with inventors Jason Simione and John Simione, U.S. Patent Application Number US20100088797, and assigned herewith to Bulldog Equipment, LLC of Hollywood, Florida, which is hereby incorporated by reference in its entirety. A variation of this pattern is shown in the design application entitled “Substrate with Camouflage Pattern”, with inventors Jason Simione and John Simione, U.S. patent application Ser. No. 29/303,336, now USD602258, and assigned herewith to Bulldog Equipment, LLC of Hollywood, Florida, which is hereby incorporated by reference in its entirety.

These layers 902 through 910 may be glued, sewn, ultrasonically bonded, or a combination, together and can be formed into a variety of shapes and applications as shown in FIG. 1 through FIG. 7.

An optional 2″×2″ grid pattern sewn with 550 cord 914 enables attachment of foliage or Jute when the material in this example is formed into a hooded cape shown in FIG. 2 through FIG. 5.

A series of through holes or vents 930 are formed through all the layers 902 through 910. These vents allow the cloaking material to be compressed and folded for transport and storage. For example, the cloaking material section may be up to 60 inches wide, and has vents 930 approximately every 12 inches.

### Second Example of IR Cloaking Material Without Bubble Layer

FIG. 10 is a third example of a side view 1000 illustrating the layers of the IR cloaking material to cover items such as tent flys that are at ambient temperature. There are multiple layers of material. Layer 1002 is a synthetic fabric, such as nylon or polyester. Examples of synthetic fabric include, but are not limited to Cordura® fabric, Sunbrella® fabric, and Weblon® fabric. An optional first camouflage pattern 1012 is printed on the outside of the synthetic fabric 1002. Next is a metalized film layer 1004 of highly reflective metalized film, such as aluminum polyester film. This metalized film layer 1004 a highly reflective metalized film, such as aluminum polyester film. The design and construction of the metalized file provide the ability to reduce or eliminate the thermal signature. The metalized film can be made of various types of metals/and metallic coatings, ranging from gold, silver, nickel, aluminum, copper, mylar, graphene, and other similar materials or combinations thereof. This is applied in manners and thickness so as to disrupt the ability of the IR cameras to penetrate the material substrate to which they are bonded. The layers 1002, 1004 and 1010 form an industrialized strength, lightweight yet durable insulation, and are a fire-rated radiant barrier. An example of such material is available from US Energy Products, located in Miami, Florida.

Layer 1010 is a synthetic fabric, such as nylon or polyester, as described for the first layer 1002. An optional second camouflage pattern 1020 is printed on the outside of the synthetic fabric 1010. The first camouflage pattern and the second camouflage pattern may be the same pattern. However, to increase versatility, the first camouflage pattern may be different than the second camouflage pattern. For example, the first camouflage pattern may be a desert camouflage pattern, and the second camouflage pattern is a forest or winter snow pattern. “Camouflage Pattern Applied to A Surface” with inventors Jason Simione and John Simione, U.S. Patent Application Number US20100088797, and assigned herewith to Bulldog Equipment, LLC of Hollywood, Florida, which is hereby incorporated by reference in its entirety. A variation of this pattern is shown in the design application entitled “Substrate with Camouflage Pattern”, with inventors Jason Simione and John Simione, U.S. patent application Ser. No. 29/303,336, now USD602258, and assigned herewith to Bulldog Equipment, LLC of Hollywood, Florida, which is hereby incorporated by reference in its entirety.

These layers 1002, 1004, and 1010 may be glued, sewn, ultrasonically bonded, or a combination, together and can be formed into a variety of shapes and applications as shown in FIG. 1 through FIG. 7.

An optional 2″×2″ grid pattern sewn with 550 cord 1014 enables attachment of foliage or Jute when the material in this example is formed into a hooded cape or ghillie shown in FIG. 2 through FIG. 5.

A series of through-holes or vents 1030 are formed through all the layers 1002, 1004, and 1010. These vents allow the cloaking material to be compressed and folded for transport and storage. For example, the cloaking material section may be up to 60 inches wide, and has vents 1030 approximately every 12 inches.

### Example of Fastening Sheets of Cloaking Tarps Together

FIG. 11 is an example of joining two or more sections of cloaking material together to cover larger objects 1100, such as an army tank. Each section may be up to 60″ inches wide and any length. For example, a length of 25 Feet×25 feet is five pieces of these three layers of fabric 25 Feet long×5 feet wide joined together five Times, which equals 25 ×25. Shown are four sections of tarp cloaking materials 1102, 1104, 1106, and 1108. A series of webbing or straps 1120 are used to join the four sections together. Tri-glides such as described in the design application entitled “Tri-Glide”, with inventor Jason Simione, U.S. patent application Ser. No. 29/993,3057, filed on Mar. 12, 2025, and assigned herewith to Bulldog Equipment, LLC of Hollywood, Florida, which is hereby incorporated by reference in its entirety.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. An infrared (IR) cloaking material comprising:
a layer of metalized film,
a first layer of fabric with an outer surface and an inner surface, and a second layer of fabric with an outer surface and an inner surface, in which the layer of metalized film is bonded between the first layer of fabric and the second layer of fabric;
a plurality of vents formed as a continuous opening through the outer surface of the first layer of fabric, through the first layer of fabric, through the layer of metalized film, through the second layer of fabric, and through the outer surface of the second layer of fabric; and
at least one of i) a camouflage pattern disposed on the outside surface of the first layer of fabric, ii) a grid pattern of cord fastened to the outer surface of the first layer of fabric, or iii) both.

2. The IR cloaking material of claim 1, further comprising:
another camouflage pattern is disposed on the outside surface of the second layer of fabric, which is different than the camouflage pattern disposed on the outer surface of the first layer of fabric.

3. The IR cloaking material of claim 1, wherein the layer of metalized film is one of gold, silver, nickel, aluminum, copper, mylar, graphene, or combinations thereof.

4. An infrared (IR) cloaking material comprising:
a first layer of fabric with an outer surface and an inner surface;
a second layer of metalized film;
a third layer of plastic film with a plurality of air bubbles formed therein;
a fourth layer of metalized film;
a fifth layer of fabric with an outer surface and an inner surface, wherein the first layer, the second layer, the third layer, the fourth layer and the fifth layer are all bonded together; and
a plurality of vents formed as a continuous opening through the outer surface of the first layer of fabric, through the first layer, through the second layer, through the third layer, through the fourth layer, through the fifth layer, and through the outer surface of the fifth layer.

5. The IR cloaking material of claim 4, further comprising:
at least one of i) a camouflage pattern disposed on the outside surface of the first layer of fabric, ii) a grid pattern of cord fastened to the outer surface of the first layer of fabric, or iii) both.

6. The IR cloaking material of claim 5, further comprising:
another camouflage pattern is disposed on the outside surface of the second layer of fabric, which is different than the camouflage pattern disposed on the outer surface of the first layer of fabric.

7. The IR cloaking material of claim 4, wherein the second layer of metalized film and the fourth layer of metalized film is one of gold, silver, nickel, aluminum, copper, mylar, graphene, or combinations thereof.

8. The IR cloaking material of claim 4 is formed into a cape with a hood.

9. An infrared (IR) cloaking material shaped as a cape comprising:
a fabric with an outside surface and an inside surface with
a metallic coating applied to the inside surface of the fabric;
a camouflage pattern disposed on the outside surface of the fabric; and
a plurality of zig-zag stitching sewn between the outside surface and inside surface of the fabric; and
a cape made from the fabric, the cape including arm portions.

10. The cape of claim 9, wherein the metallic coating is one of gold, silver, nickel, aluminum, copper, mylar, graphene, carbon or combinations thereof.

11. The cape of claim 9, further comprising:
a grid pattern of cord fastened to the outside surface of the fabric.

12. The cape of claim 9 further comprising:
a hood with an outside surface and an inside surface made from the fabric with a metallic coating applied to the inside surface of the fabric and releasably fastened to the cape.

13. The cape of claim 12, wherein the metallic coating of the hood is one of gold, silver, nickel, aluminum, copper, mylar, graphene, carbon or combinations thereof.

14. The cape of claim 12, wherein the hood, further comprising:
a grid pattern of cord fastened to the outside surface of the fabric.

15. The cape of claim 9, further comprising:
a plurality of spacers disposed between the inside surface and a user.

16. The cape of claim 15, where the spacers are one of foam blocks, wire-stiffened arches, plastic arches, rectangular shapes, or a combination thereof.
